(19) United States
(12) Patent Application Publication
(10) Pub. No.: US 2026/0208854 A1
(43) Pub. Date: Jul. 23, 2026

(54) PROPELLERS

(71) Applicant: OnwardAir, Inc., Houston, TX (US)

(72) Inventors: David Colling, Seabrook, TX (US); Michael Richard Teeter, Cypress, TX (US); Scott Edward Parazynski, Houston, TX (US)

(21) Appl. No.: 19/452,552

(22) Filed: Jan. 19, 2026

Related U.S. Application Data
(60) Provisional application No. 63/746,449, filed on Jan. 17, 2025.

(51) Int. Cl. B64C 11/24; B64C 11/04; B64C 11/48; B64C 29/00

(52) U.S. Cl. CPC B64C 11/24; B64C 11/04; B64C 11/48; B64C 29/0025; B64C 2230/14

(57) ABSTRACT

A propeller blade extends along a length from a blade root to a blade tip and includes a leading edge, a trailing edge, a lower surface, and an upper surface. One or more intake vents are provided in one or more surfaces of the propeller blade adjacent the blade root and are oriented toward the leading edge to intake ram air during rotation of the propeller blade. A plenum is provided internal to the propeller blade and in fluid flow communication with the intake vent. One or more outlet vents are provided in one or more surfaces of the propeller blade adjacent the blade tip and are oriented to direct outlet air flow toward a flow separation target during rotation of the propeller blade effective to mitigate flow separation of air passing across the propeller blade.

### CROSS REFERENCE

The present claims the benefit of and priority to U.S. application no. 63/746,449 filed Jan. 17, 2025, and the same is hereby incorporated by reference.

### BACKGROUND

The present application relates to propellers and more particularly, but not exclusively, to propellers for aircraft lift fans, propellers for forward propulsion, and related apparatuses, systems, and processes.

A number of proposals have been made to provide lift fan and propulsion propellers for aircraft. Existing proposals suffer from a number of disadvantages, shortcomings, and unmet needs including those respecting, complexity, durability, efficacy, efficiency, and reliability, among others. There remains a significant need for the unique apparatuses, processes, and systems disclosed.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include apparatuses including unique propellers. Some embodiments include unique processes including unique propellers. Some embodiments include unique systems including unique propellers. Further embodiments, forms, objects, features, advantages, aspects, and benefits shall become apparent from the following description and drawings.

### BRIEF DESCRIPTION OF THE DRAWINGS

FIG. 1 is a perspective view depicting certain aspects of an example aircraft.

FIG. 2A is a perspective view depicting certain aspects of a lift fan assembly of the aircraft of FIG. 1 in a first configuration.

FIG. 2B is a perspective view depicting certain aspects of a lift fan assembly of the aircraft of FIG. 1 in a second configuration.

FIG. 2C is a perspective view depicting certain aspects of a lift fan assembly of the aircraft of FIG. 1 in a third configuration.

FIG. 3 is a perspective depicting certain aspects of another example aircraft.

FIG. 4 is a bottom perspective view depicting certain aspects of a propeller of the lift fan assembly of FIGS. 2 and 3.

FIG. 5 is a top perspective view depicting certain aspects of a propeller of the lift fan assembly of FIGS. 2 and 3.

FIG. 6 is a sectional view depicting certain aspects of the propeller of FIGS. 4 and 5.

FIG. 7 is a sectional view depicting certain aspects of the propeller of FIGS. 4 and 5.

FIG. 8A is a sectional view depicting certain aspects of an intake vent of the propeller of FIGS. 4 and 5.

FIG. 8B is a bottom perspective view depicting certain aspects of an intake vent of FIG. 6.

FIG. 9 is a top perspective view depicting certain aspects of the propeller of FIGS. 4 and 5.

FIG. 10 is a top perspective view depicting certain aspects of another example propeller suitable for use with the lift fan assembly of FIGS. 2 and 3.

FIG. 11 is a bottom perspective view depicting certain aspects of the propeller of FIG. 10.

FIG. 12 is a leading edge side perspective view depicting certain aspects of the propeller of FIG. 10.

FIG. 13 is a trailing edge side perspective view depicting certain aspects of the propeller of FIG. 10.

FIG. 14 is a top perspective view depicting certain aspects of the propeller of FIG. 10.

FIG. 15 is a leading edge perspective view depicting certain aspects of an intake vent of the propeller of FIG. 10.

FIG. 16 is a leading edge perspective view depicting certain aspects of another example embodiment of an intake vent of the propeller of FIG. 10.

FIG. 17 is a leading edge perspective view depicting certain aspects of another example embodiment of an intake vent of the propeller of FIG. 10.

FIG. 18 is a trailing edge perspective view depicting certain aspects of an outlet vent of the propeller of FIG. 10.

FIG. 19 is a trailing edge perspective view depicting certain aspects of another example embodiment of an outlet vent of the propeller of FIG. 10.

FIG. 20 is a trailing edge perspective view depicting certain aspects of another example embodiment of an outlet vent of the propeller of FIG. 10.

FIG. 21 is a partially schematic view depicting certain aspects of an example flow passage the propeller of FIG. 10.

### DETAILED DESCRIPTION OF EXAMPLE EMBODIMENTS

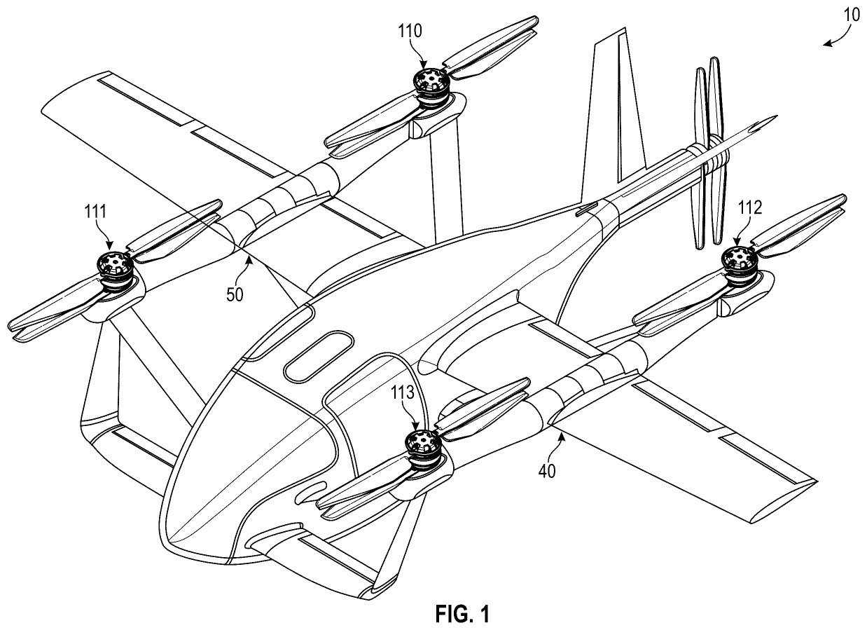

Referring now to the figures with initial reference to FIG. 1, there is illustrated an example aircraft 10. In the illustrated example, aircraft 10 includes an airframe 11 including a fuselage 20, landing gear 30, reconfigurable wing 40, and reconfigurable wing 50. Fuselage 20 includes cockpit 25 which is configured to accommodate a pilot, cargo or other human occupant of aircraft 10. Aircraft 10 includes a plurality of lift fan assemblies including lift fan assembly 110, lift fan assembly 111, lift fan assembly 112, and lift fan assembly 113 which are configured and operable to rotate respective propellers to provide vertical take-off and landing (VTOL) operation of aircraft 10.

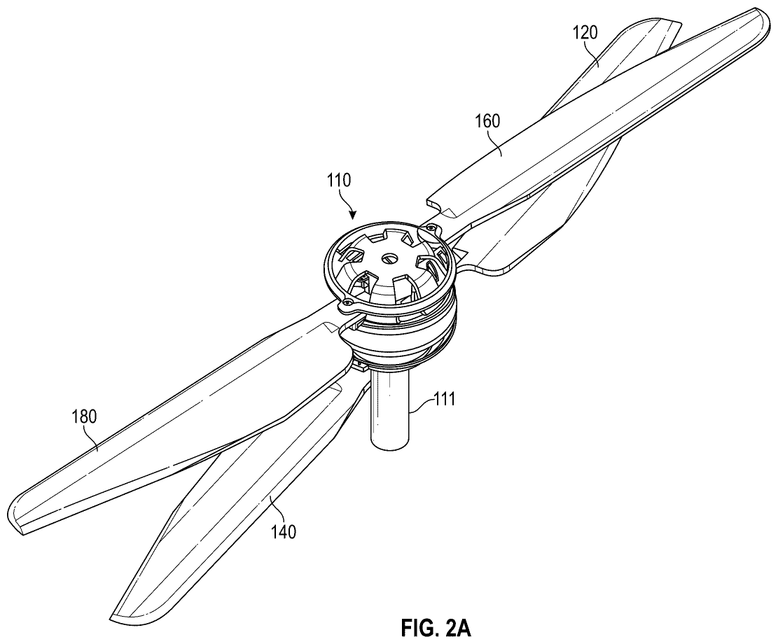

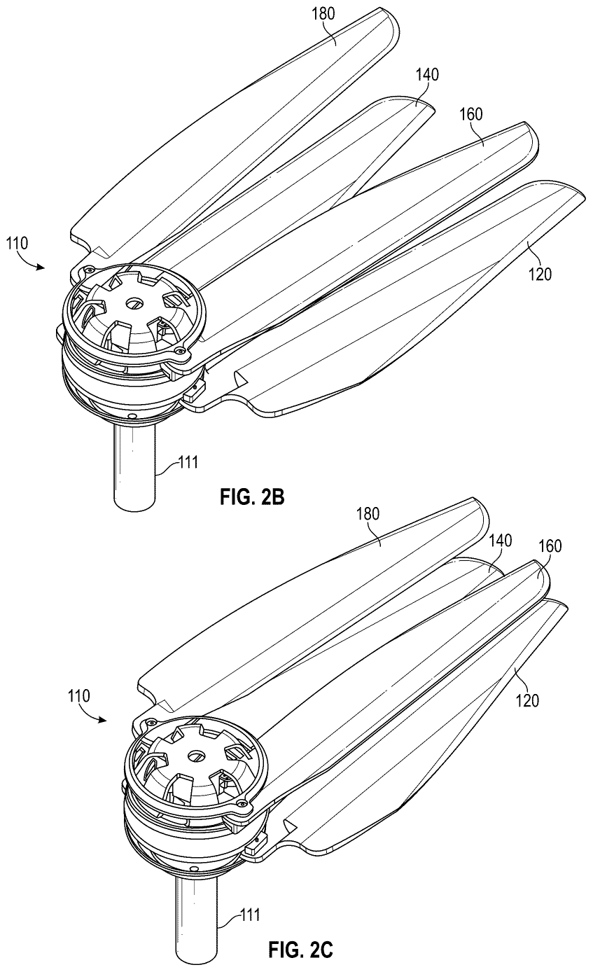

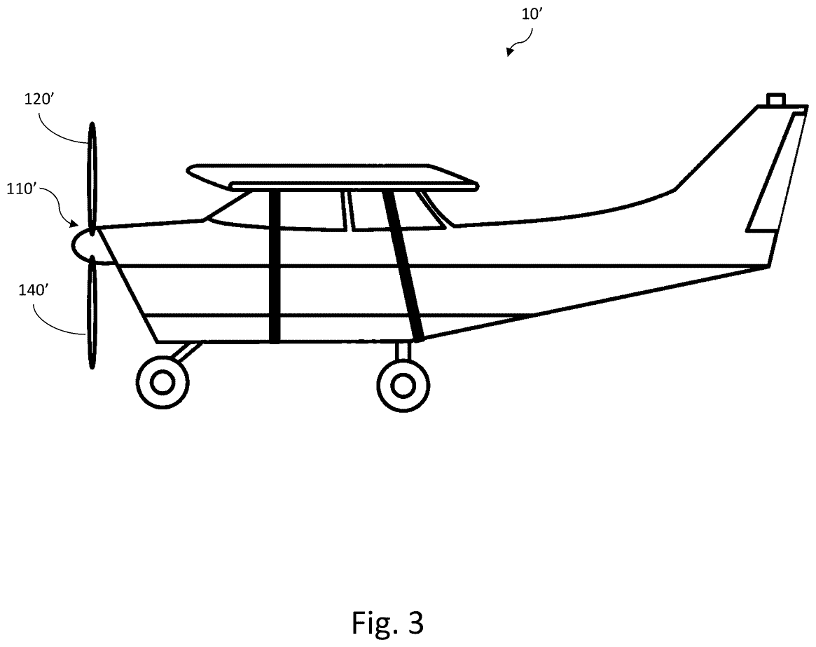

As further illustrated in FIGS. 2 and 3, lift fan assembly 110 includes a plurality of propeller blades including propeller blade 120, propeller blade 140, propeller blade 160, and propeller blade 180 which are operatively coupled with and extend radially outward from a central hub 70. One or more electric motors 71 are provided and configured to drive rotation of central hub 70 or a portion thereof. In some embodiments, one or more shafts driven by one or more internal combustion engines may be utilized to drive rotation of central hub 70. Some embodiments may comprise other propeller configurations including single propeller blades, multi-blade propeller configurations with or without the capability to pivot about a central hub, stacked propeller blade configurations (e.g., uni-directional or counter-rotating), fixed pitch propellers, and variable pitch propellers, any of which may include equivalent or different pitch and variable length if blades.

It shall be appreciated that the attributes, components, features, functionality, operation, and structures of lift fan assembly 110 are also present in lift fan assembly 111, lift fan assembly 112, and lift fan assembly 113. Accordingly, the description of lift fan assembly 110 and its the attributes, components, features, functionality, operation, and structures shall be understood to apply to and also describe lift fan assembly 111, lift fan assembly 112, and lift fan assembly 113.

In the illustrated example, propeller blade 120 and propeller blade 140 are configured and provided as a first set of radially opposing blades configured to rotate in a first direction about central hub 70. Propeller blade 160 and propeller blade 180 are configured and provided as a second set of radially opposing blades configured to rotate in a second direction opposite the first direction central hub 70. In some embodiments, the first set of propeller blades and the second set of propeller blades may be driven by a common set of one or more electric motors, for example, by a single electric motor and a gearset configured to drive a first shaft associated with central hub 70 in the first direction and to drive a second shaft associated with central hub 70 in the second direction. In some embodiments, the first set of propeller blades and the second set of propeller blades may be driven by separate electric motors.

As illustrated in FIG. 2A, propeller blade 120, propeller blade 140, propeller blade 160, and propeller blade 180 may be adjusted to an extended position wherein propeller blade 120 extends in an opposite or radially opposed direction from propeller blade 140 and propeller blade 160 extends in an opposite or radially opposed direction from propeller blade 180. As illustrated in FIG. 2B, propeller blade 120, propeller blade 140, propeller blade 160, and propeller blade 180 may be adjusted to a partially retracted positions wherein propeller blade 120 and propeller blade 140 are rotated toward one another, and propeller blade 160 and propeller blade 180 are rotated toward one another. As illustrated in FIG. 2C, propeller blade 120, propeller blade 140, propeller blade 160, and propeller blade 180 may be adjusted to a maximally retracted positions wherein propeller blade 120 and propeller blade 140 are further rotated toward one another, and propeller blade 160 and propeller blade 180 are further rotated toward one another. In the illustrated example, such adjustment is provided by rotating propeller blade 120, propeller blade 140, propeller blade 160, and propeller blade 180 about respective connection points with central hub at their respective root portions while maintaining central hub110in a fixed position.

With reference to FIG. 3, there is illustrated another example aircraft a substantial portion present illustrates and describes unique aircraft propellers configured and provided as components of a lift fan, it shall be appreciated that aircraft propellers according to the present disclosure bay be configured and provided as forward or horizontal propulsion propellers for aircraft, there is illustrated another example aircraft 10′ including a forward propeller system 110′ which includes propeller blade 120′ and propeller blade 140′. It shall be appreciated that the components, features, functionality, and structures described in connection with the lift fan assemblies and propeller blade 120, propeller blade 140, propeller blade 160, and propeller blade 140′ are also applicable to and may be included in forward propeller system 110′, propeller blade 120′, and propeller blade 140′.

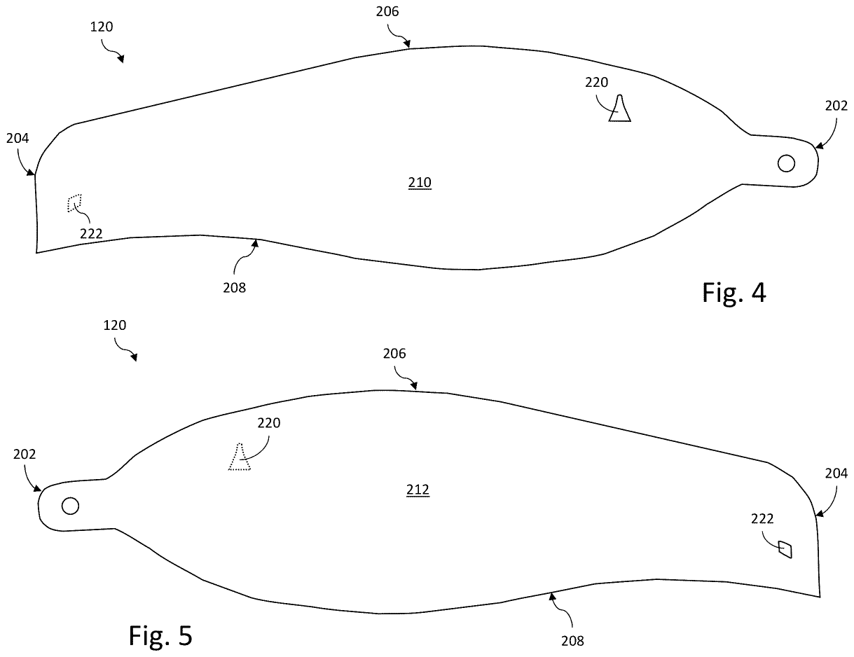

As further illustrated in FIGS. 4 and 5, propeller blade 120 along a length from a blade root 202 to a blade tip 204. Propeller blade 120 further includes a trailing edge 208, a trailing edge 208, a lower surface 210, and an upper surface 212 which are configured and provided in the form of an aerofoil configured and operable to provide lift force when rotated.

Intake vent 220 is provided and formed in lower surface 210 adjacent blade root 202 and is oriented toward trailing edge 208 to intake ram air during rotation of propeller blade 120. Intake vent 220 is an example of an intake vent configured and operable to receive and intake air flow during operation of a propeller blade according to the present disclosure. It shall be appreciated that providing and forming intake vent 220 in lower surface 210 may be preferred for certain embodiments, applications, and use cases since, during operation of propeller blade 120, lower surface 210 is a relatively high pressure region exposed to higher air pressures than other locations of propeller blade 120. Such higher pressure regions may promote air flow into intake vent 220. Nevertheless, as further described herein, a number of other locations and positions of intake vents are contemplated.

While intake vent 220 is depicted as single intake vent in the illustrated example, it is contemplated that multiple intake vents may be provide in propeller blade 120 or other propellers according to the present disclosure. Additionally, while intake vent 220 is depicted as being provided or formed in lower surface 210 of propeller blade 120, it is contemplated that intake vent 220 and other intake vents according to the present disclosure may be provided and formed in alternate locations or in additional locations in embodiments including multiple intake vents.

In some embodiments, intake vent 220 or other intake vents according to the present disclosure may be provided and formed, in whole or in part, in trailing edge 208 of propeller blade 120 or a leading edge of other propeller blades according to the present disclosure. In some embodiments, intake vent 220 or other intake vents according to the present disclosure may be provided and formed, in whole or in part, in upper surface 212 of propeller blade 120 or an upper surface of other propeller blades according to the present disclosure. It is further contemplated that intake vent 220 or other intake vents according to the present disclosure may be provided and formed in combinations of multiple surfaces of propeller blade 120 or a leading edge of other propeller blades according to the present disclosure.

In some embodiments, intake vent 220 or other intake vents according to the present disclosure may be provided and formed, in whole or in part, in a combination of lower surface 210 and trailing edge 208 of propeller blade 120 or a combination of a lower surface and a leading edge of other propeller blades according to the present disclosure. In some embodiments, intake vent 220 or other intake vents according to the present disclosure may be provided and formed, in whole or in part, in a combination of lower surface 210, trailing edge 208, and upper surface 212 of propeller blade 120 or a combination of a lower surface, a leading edge, and an upper surface of other propeller blades according to the present disclosure. In some embodiments, intake vent 220 or other intake vents according to the present disclosure may be provided and formed, in whole or in part, in a combination of trailing edge 208 and upper surface 212 of propeller blade 120 or a combination of a leading edge and an upper surface of other propeller blades according to the present disclosure.

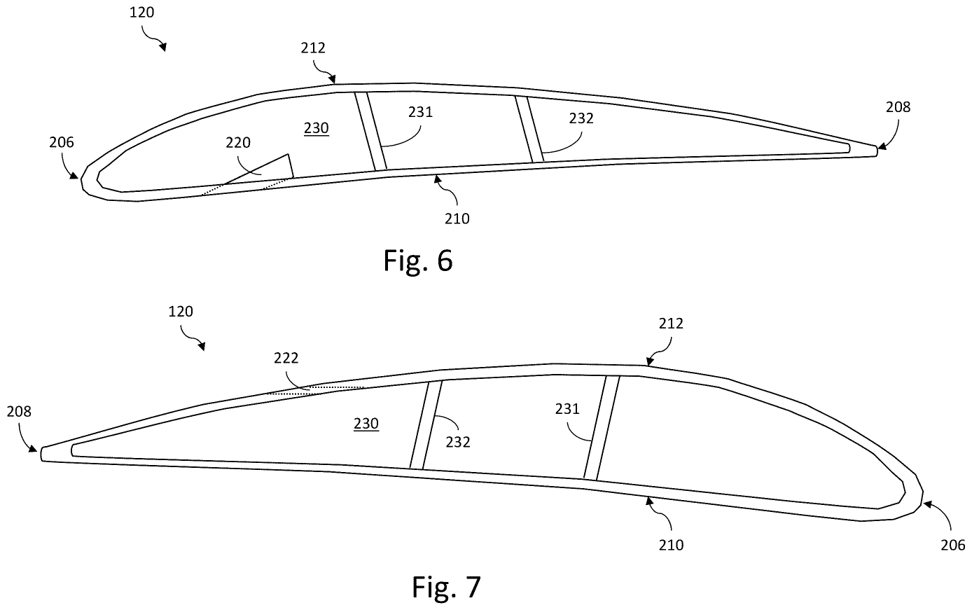

As further illustrated in FIGS. 6 and 7, a plenum 230 is provided internal to propeller blade 120 and is in fluid flow communication with intake vent 220 and outlet vent 222 of propeller blade 120. Plenum 230 is an example of an internal flow passage of a propeller blade according to the present disclosure. Plenum 230 and other internal flow passages of propeller blades according to the present disclosure are preferably configured and structured to promote laminal flow of air between an intake vent and an outlet vent of a propeller blade, for example, by including and providing smooth and curved flow passage guide surfaces between an intake vent and an outlet vent. Such flow passages may be configured to minimize or mitigate obstruction of such flow. Plenum 230 may be configured and provided in a number or forms and geometries including, for example, an S-shaped or sigmoid curve or other suitable curves as will occur to one of skill in the art with the benefit and insight of the present disclosure.

An outlet vent 222 is provided and formed in upper surface 212 adjacent blade tip 204 and is in fluid flow communication with plenum 230. Outlet vent 222 is an example of an outlet vent configured and operable to receive and output air flow from an interior passage of a propeller blade according to the present disclosure during operation of such a propeller blade. Outlet vent 222 is an example of an outlet vent configured and operable to output and direct air flow toward a flow separation target. Flow separation generally refers to air flow and/or air pressure conditions causing air flow across a surface of the propeller blade to detach from that surface. A flow separation target according to the present disclosure refers to a targeted area, volume, or region adjacent a surface of a propeller blade that avoids, mitigates, or reduces flow operation during operation of a propeller blade according to the present disclosure.

Flow separation may lead to significant changes in flow behavior such as blade tip or blade edge vortex formation, increases in blade tip of blade edge vortex size, wake formation, turbulence or non-laminar flow, increased drag, reduced lift, and other undesired operating conditions as will occur to one of skill in the art with the benefit and insight of the present disclosure. By directing output air flow toward a flow separation target, outlet vent 222 and other outlet vents according to the present disclosure can avoid, mitigate, or reduce flow separation and its attendant undesired operating conditions.

Flow separation targets according to the present disclosure may include regions of an upper surface of a propeller blade (e.g., such as upper surface 212 of propeller blade 120) which are at, adjacent a blade tip of a propeller blade, (e.g., such as blade tip 204 of propeller blade 120). Such regions may be at a maximum thickness of the propeller blade, extending or offset forward adjacent to the maximum thickness (e.g., 10%-30% of the distance from a leading edge to a trailing edge), or extending or offset rearward adjacent to the maximum thickness (e.g., 10%-30% of the distance from a leading edge to a trailing edge).

It shall be appreciated that providing and forming outlet vent 222 in upper surface 212 may be preferred for certain embodiments, applications, and use cases since, during operation of propeller blade 120, upper surface 212 is a relatively low pressure region exposed to lower air pressures than other locations of propeller blade 120. Such lower pressure regions may promote air flow out of outlet vent 222 and/or direct such air flow toward flow separation targets at or adjacent an upper surface of a propeller blade according to the present disclosure. Nevertheless, as further described herein, a number of other locations and positions of outlet vents are contemplated.

While outlet vent 222 is depicted as single outlet vent in the illustrated example, it is contemplated that multiple outlet vents may be provide in propeller blade 120 or other propellers according to the present disclosure. Additionally, while outlet vent 222 is depicted as being provided or formed in upper surface 212 of propeller blade 120, it is contemplated that outlet vent 222 and other outlet vents according to the present disclosure may be provided and formed in alternate locations or in additional locations in embodiments including multiple outlet vents.

In some embodiments, outlet vent 222 or other outlet vents according to the present disclosure may be provided and formed, in whole or in part, in trailing edge 208 of propeller blade 120 or a trailing edge of other propeller blades according to the present disclosure. In some embodiments, outlet vent 222 or other outlet vents according to the present disclosure may be provided and formed, in whole or in part, in lower surface 210 of propeller blade 120 or a lower surface of other propeller blades according to the present disclosure. It is further contemplated that outlet vent 222 or other outlet vents according to the present disclosure may be provided and formed in combinations of multiple surfaces of propeller blade 120 or a trailing edge of other propeller blades according to the present disclosure.

In some embodiments, outlet vent 222 or other outlet vents according to the present disclosure may be provided and formed, in whole or in part, in a combination of upper surface 212 and trailing edge 208 of propeller blade 120 or a combination of an upper surface and a trailing edge of other propeller blades according to the present disclosure. In some embodiments, outlet vent 222 or other outlet vents according to the present disclosure may be provided and formed, in whole or in part, in a combination of lower surface 210, trailing edge 208, and upper surface 212 of propeller blade 120 or a combination of a lower surface, a trailing edge, and an upper surface of other propeller blades according to the present disclosure. In some embodiments, outlet vent 222 or other outlet vents according to the present disclosure may be provided and formed, in whole or in part, in a combination of trailing edge 208 and lower surface 210 of propeller blade 120 or a combination of a trailing edge and an upper surface of other propeller blades according to the present disclosure.

Outlet vent 222 is oriented, configured, and operable to direct outlet air flow along upper surface 212 toward trailing edge 208 during rotation of propeller blade 120. One or more support structures 231, 232 may extend across respective portions of plenum 230 to define chambers or sections thereof and may be coupled with lower surface 210, upper surface 212, and/or various other structures of propeller blade 120 to impart strength or rigidity thereto.

In the illustrated example, intake vent 220 is configured and provided as a NACA scoop or NACA vent. In other embodiments, other types of intake vents may be utilized including, for example, a rectangular scoop, a ram air scoop, or other intake vent configurations, types, and geometries as will occur to one of skill in the art with the benefit and insight of the present disclosure.

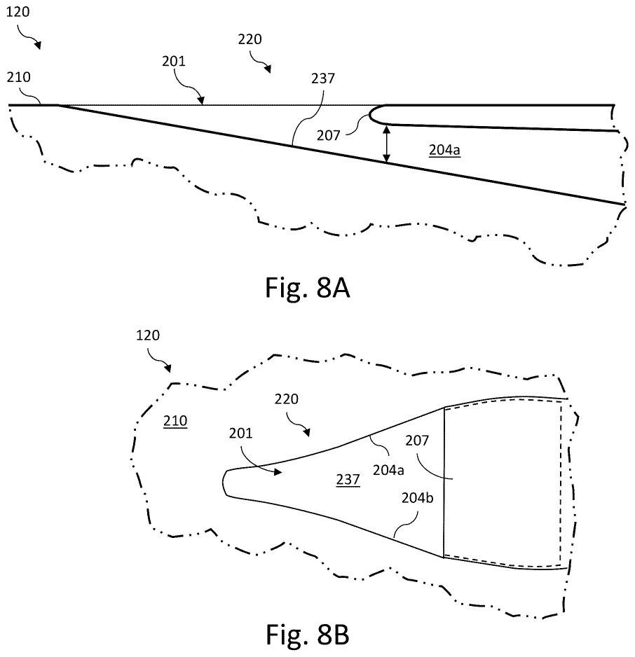

As further illustrated in FIGS. 8A and 8B, intake vent 220 includes an intake aperture 201 which is configured and provided in a substantially flush relationship with lower surface 210. Intake vent 220 includes a ramp floor 237 extending into propeller blade 120 from intake aperture 201. Ramp floor 237 extends lengthwise from a leading edge of the intake aperture 201 at an angle toward the trailing edge 208 and the upper surface 212 of the propeller blade 120.

Intake vent 220 also includes an edge lip 207 spaced apart from ramp floor 237 and extending from a trailing edge of intake aperture 201 toward trailing edge 208 of propeller blade 120. Intake vent 220 further includes first and second diverging curved sidewalls 204a, 204b extending from a leading edge of intake aperture 201 at an angle toward trailing edge 208 of propeller blade 120. First and second diverging curved sidewalls 204a, 204b bound a width of intake vent 220. The width tapers from a first magnitude adjacent edge lip 207 to a second magnitude less than the first magnitude adjacent a leading edge of the intake aperture 201.

While a single intake vent is provided in the illustrated example, it shall be appreciated that some embodiments may comprise multiple intake vents. Additionally, some embodiments may comprise one or more intake vents that are positioned at different locations on lower surface 210 or a lower surface of another propeller. Furthermore, some embodiments may comprise one or more intake vents that are configured and provided with configurations, geometries, and/or sizing varying from that of the illustrated example.

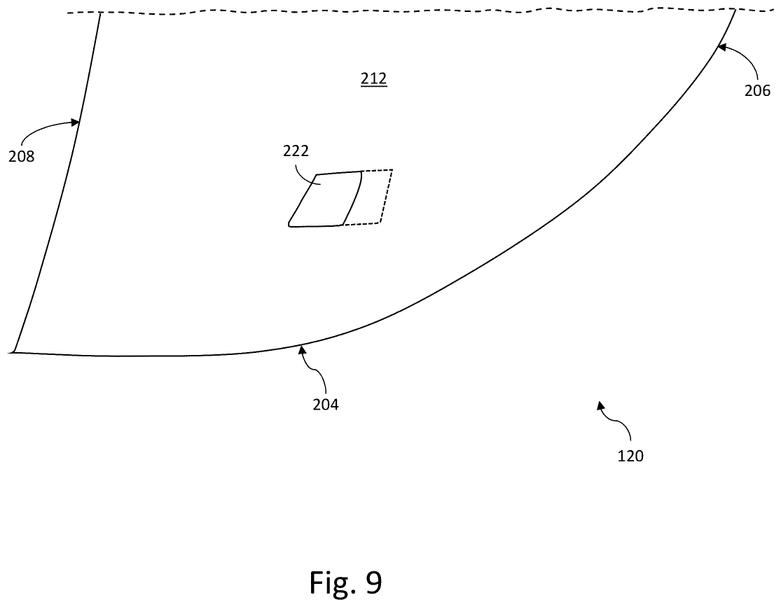

With additional reference to FIG. 9, outlet vent 222 is oriented to direct air flow across upper surface 212 toward trailing edge 208 of propeller blade 120. Outlet vent 222 is configured and effective to mitigate flow separation over at least a portion of the upper surface during rotation of the propeller blade. The air flow directed across the upper surface is effective to mitigate boundary layer flow separation. Outlet vent 222 may be positioned at or adjacent a region of maximal air flow over upper surface 212 during rotation of propeller blade 120.

While a single outlet vent is provided in the illustrated example, it shall be appreciated that some embodiments may comprise multiple outlet vents. Additionally, some embodiments may comprise one or more outlet vents that are positioned at different locations on upper surface 212 or an upper surface of another propeller. Furthermore, some embodiments may comprise one or more outlet vents that are configured and provided with configurations, geometries, and/or sizing varying from that of the illustrated example.

It shall be appreciated that the attributes, components, features, functionality, operation, and structures of propeller blade 120 are also present in propeller blade 140, propeller blade 160, and propeller blade 180. Accordingly, the description of propeller blade 120 and its attributes, components, features, functionality, operation, and structures shall be understood to apply to and also describe propeller blade 140, propeller blade 160, and propeller blade 180.

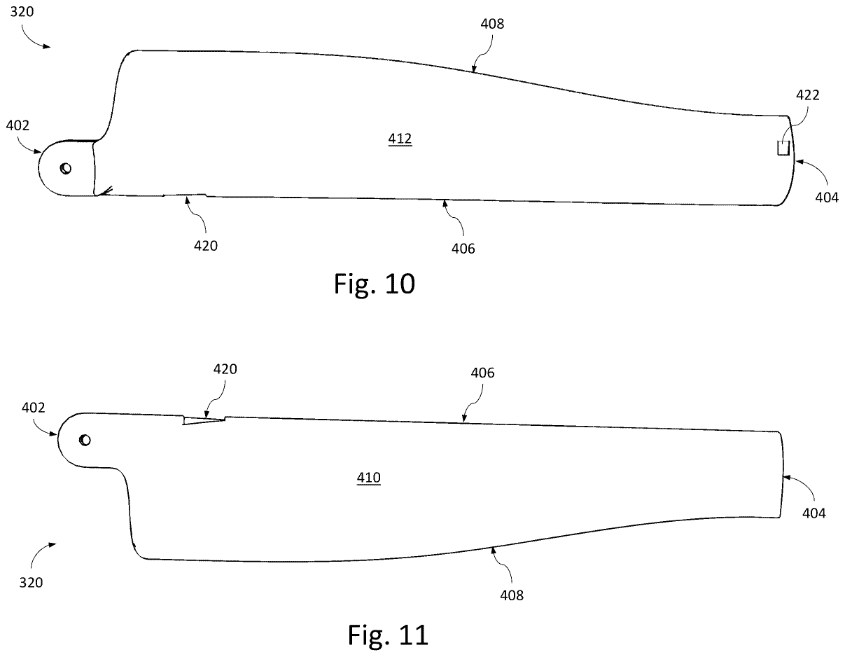

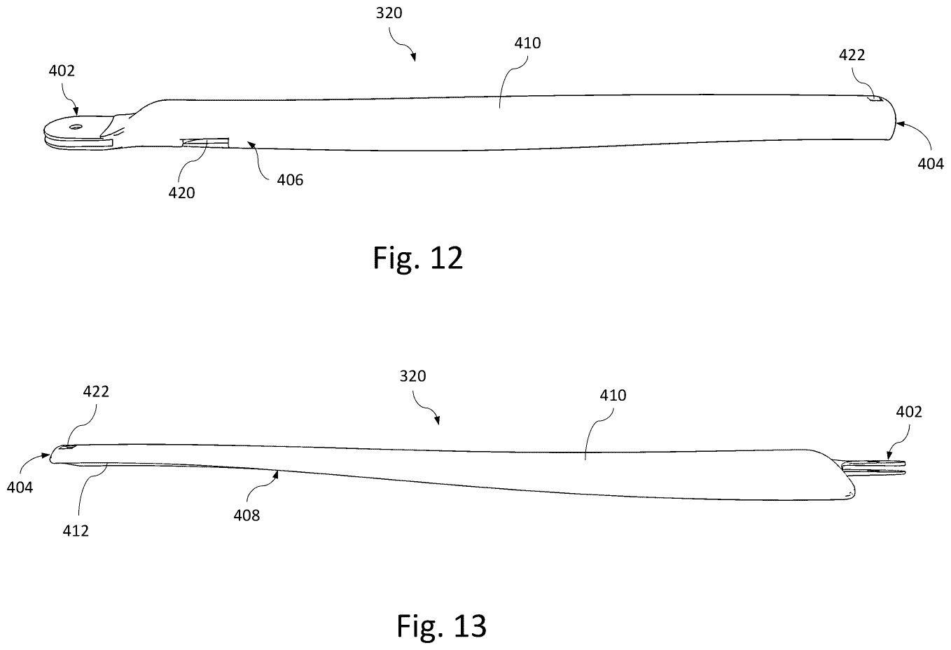

With reference to FIGS. 10-21, there is illustrated another example propeller blade 320. Propeller blade 320 may be utilized in connection with a lift fan assembly of an aircraft, such as lift fan assembly 110 of aircraft 10. For example, propeller blades according to propeller blade 320 may be operatively coupled with a central hub, such as central hub 70 of lift fan assembly 110, in place of propeller blade 120, propeller blade 140, propeller blade 160, and propeller blade 180. Propeller blade 320 or variations thereof may be utilized in connection with the other technical contexts, applications and use cases disclosed herein.

Propeller blade 320 extends along a length from a blade root 402 to a blade tip 404. Propeller blade 320 further includes a leading edge 406, a trailing edge 408, a lower surface 410, and an upper surface 412 which are configured and provided in the form of an aerofoil configured and operable to provide lift force when rotated.

The configuration and shape of propeller blade 320 varies from that of propeller blade 120 in a number of respects. For example, leading edge 406 of propeller blade 320 has a generally straight configuration and shape, whereas trailing edge 208 of propeller blade 120 has a curved or swept configuration and shape. Additionally, trailing edge 408 of propeller blade 320 has a swept or curved configuration and shape that is with a less pronounced curvature than trailing edge 206 of propeller blade 120. Furthermore, blade tip 404 of propeller blade 320 has a generally straight configuration and shape, whereas blade tip 204 of propeller blade 120 has a curved or swept configuration and shape. Further variations in the configuration and shape of propeller blade 320 varies from that of propeller blade 120 are illustrated in the drawings.

As illustrated in detail in FIGS. 15-17, intake vent 420 is provided and formed in a combination of lower surface 410 and leading edge 406 adjacent blade root 402 and is oriented toward leading edge 406 to intake ram air during rotation of the propeller blade. It shall be appreciated that intake vent 420 may be considered to be provided in part in upper surface 412 as it extends to some extent upward from the forward most portion of leading edge 406. Nevertheless, a substantial majority of the intake area of intake vent 420 is provided in a combination of lower surface 410 and leading edge 406.

Intake vent 420 is an example of an intake vent configured and operable to receive and intake air flow during operation of a propeller blade according to the present disclosure. It shall be appreciated that providing and forming intake vent 420 in lower surface 410 may be preferred for certain embodiments, applications, and use cases since, during operation of propeller blade 120, lower surface 410 is a relatively high pressure region exposed to higher air pressures than other locations of propeller blade 120 and leading edge 406 also encounters higher pressures and encounters higher ram air flow that other locations of propeller blade 120. Such higher pressure and high ram air flow regions may promote air flow into intake vent 420. Nevertheless, as further described herein, a number of other locations and positions of intake vents are contemplated.

Intake vent 420 includes a ceiling 447 and a floor 437 extending into propeller blade 320 from intake aperture 401. Ceiling 447 extends lengthwise from an upper lip 448 of intake aperture 401 positioned adjacent upper surface 412 and leading edge 406 toward trailing edge 408 of propeller blade 320. Floor 437 extends lengthwise from a lower lip 438 of intake aperture 401 toward trailing edge 408 of propeller blade 320. Intake vent 420 further includes first and second sidewalls 404a, 404b extending from leading edge 406 of intake aperture 401 toward trailing edge 408 of propeller blade 320. First and second sidewalls 404a, 404b bound a width of intake vent 420.

While intake vent 420 is depicted as single intake vent in the illustrated example, it is contemplated that multiple intake vents may be provide in propeller blade 120 or other propellers according to the present disclosure. Additionally, while intake vent 420 is depicted as being provided or formed in lower surface 410 of propeller blade 120, it is contemplated that intake vent 420 and other intake vents according to the present disclosure may be provided and formed in alternate locations or in additional locations in embodiments including multiple intake vents.

In some embodiments, intake vent 420 or other intake vents according to the present disclosure may be provided and formed, in whole or in part, in leading edge 406 of propeller blade 120 or a leading edge of other propeller blades according to the present disclosure. In some embodiments, intake vent 420 or other intake vents according to the present disclosure may be provided and formed, in whole or in part, in upper surface 412 of propeller blade 120 or an upper surface of other propeller blades according to the present disclosure. It is further contemplated that intake vent 420 or other intake vents according to the present disclosure may be provided and formed in combinations of multiple surfaces of propeller blade 120 or a leading edge of other propeller blades according to the present disclosure.

In some embodiments, intake vent 420 or other intake vents according to the present disclosure may be provided and formed, in whole or in part, in a combination of lower surface 410 and leading edge 406 of propeller blade 120 or a combination of a lower surface and a leading edge of other propeller blades according to the present disclosure. In some embodiments, intake vent 420 or other intake vents according to the present disclosure may be provided and formed, in whole or in part, in a combination of lower surface 410, leading edge 406, and upper surface 412 of propeller blade 120 or a combination of a lower surface, a leading edge, and an upper surface of other propeller blades according to the present disclosure. In some embodiments, intake vent 420 or other intake vents according to the present disclosure may be provided and formed, in whole or in part, in a combination of leading edge 406 and upper surface 412 of propeller blade 120 or a combination of a leading edge and an upper surface of other propeller blades according to the present disclosure.

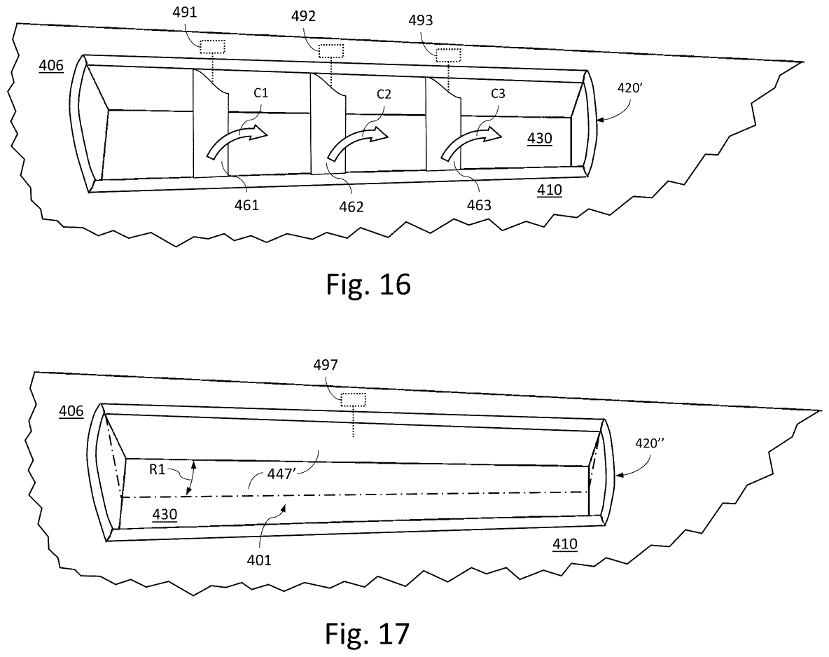

With particular reference to FIG. 16, there is illustrated another form of an intake vent 420′ including substantially similar features as those of intake vent 420 but further includes one or more vanes which are configured and operable to direct a flow in air entering intake vent toward a desired direction relative to flow passage 430. In the illustrated example the one or more vanes comprise a plurality of vanes 461, 462, 463 which are configured and operable to direct a flow in air entering intake vent toward a desired direction relative to flow passage 430 generally indicated by arrows C1, C1, C1. While the one or more vanes are illustrated as including a plurality of vanes 461, 462, 463, it shall be appreciated that other embodiments including vanes may comprise any number of one or more vanes. In some embodiments, the plurality of vanes 461, 462, 463 may have fixed tunings adapted to particular altitudes or altitude ranges. In some embodiments, the plurality of vanes 461, 462, 463 may be actuatable in response to changs in propeller speed and/or changes in air flow into intake vent. Such adjustment may be passive, for example, using one or more check valves or diaphragm valves such as a diving board diaphragm. Active actuation is also contemplated and may utilize one or more actuators such as piezoelectric actuators, solenoid actuators, spring-loaded actuators, or other actuators as will occur to one of skill in the art with the benefit and insight of the present disclosure. For example, in embodiments where active or passive actuation is utilized for vanes 461, 462, 463, actuators 491, 492, 493 may be provided in operative communication with vanes 461, 462, 463, and may be configured and provided as any of the foregoing types of actuators.

With particular reference to FIG. 17, there is illustrated another form of an intake vent 420 including substantially similar features as those of intake vent 420 but further includes one or more repositionable surfaces configured and operable to move to vary an amount or direction of a flow in air entering intake vent. In the illustrated example one or more repositionable surfaces comprises repositionable ceiling 447′ which is configured and operable for repositioning as generally illustrated by arrow R1 to vary an area intake aperture 401 and thereby vary an amount or mass flow rate of air flow in air entering outlet vent 422″. While a single repositionable surface depicted in the illustrated embodiment, it shall be appreciated that other embodiments including vanes may comprise multiple repositionable surfaces. Repositionable ceiling 447′ and other repositionable surfaces according to the present disclosure may be passively actuated, for example, in response to changes in on operating speed of a propeller according to the present disclosure or actively actuated, for example, using one or more actuators which may be positioned in a propeller according to the present disclosure. Passive adjustment may utilize one or more check valves or diaphragm valves such as a diving board diaphragm. Active actuation may utilize one or more actuators such as piezoelectric actuators, solenoid actuators, spring-loaded actuators, or other actuators as will occur to one of skill in the art with the benefit and insight of the present disclosure. For example, in embodiments where active or passive actuation is utilized for repositionable ceiling 447′, actuator 497 may be provided in operative communication with repositionable ceiling 447′ and may be configured and provided as any of the foregoing types of actuators.

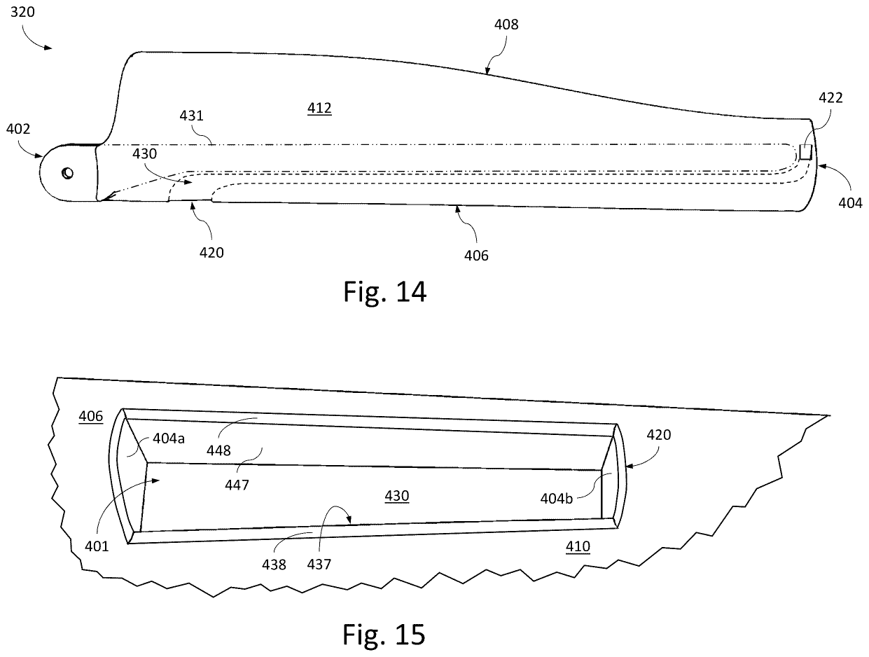

As illustrated in FIGS. 14-21, a plenum 430 is provided and formed internal to propeller blade 320 and is in fluid flow communication with intake vent 420. Plenum 430 is an example of an internal flow passage of a propeller blade according to the present disclosure and may also be referred to herein as flow passage 430. In the illustrated example, flow passage 430 is configured and structured to promote laminal flow of air between an intake vent and an outlet vent of a propeller blade by including and providing smooth, S-shaped or sigmoid guide surfaces between intake vent 420 and an outlet vent 422. The illustrated geometry of flow passage is an example of a flow passage configured to minimize or mitigate obstruction of such flow. Additionally, while flow passage 430 is illustrated as an S-shaped or sigmoid curve, other embodiment may include or utilize other suitable curves as will occur to one of skill in the art with the benefit and insight of the present disclosure.

A support spar 431 extends internally within propeller blade 320 from blade root 402 toward blade tip 404. In the illustrated example, support spar 431 is provided adjacent flow passage 430. In other embodiments, support spar 431 may be configured to define and provide a portion of a boundary of flow passage 430.

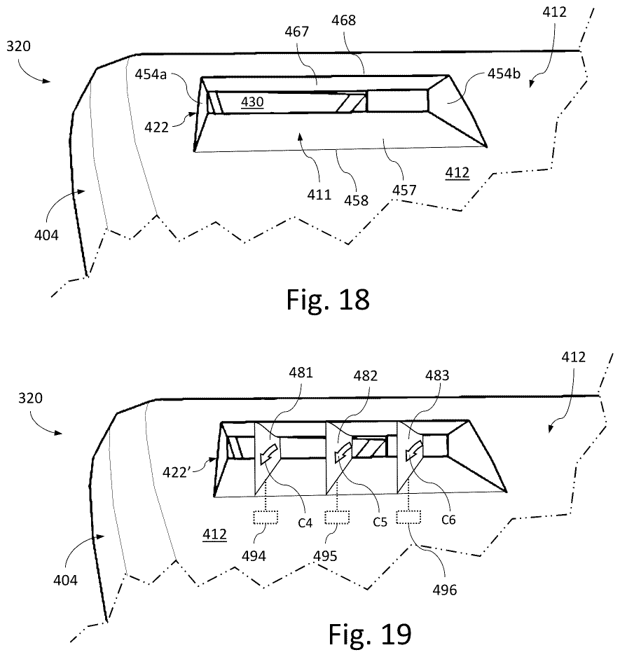

As illustrated in detail in FIGS. 18-20, outlet vent 422 is provided and formed in upper surface 412 adjacent blade tip 404 and is in is fluid flow communication with plenum 430 and is oriented, configured, and operable to direct outlet air flow along upper surface 412 toward trailing edge 408 during rotation of propeller blade 320. Outlet vent 422 is an example of an outlet vent configured and operable to receive and output air flow from an interior passage of a propeller blade according to the present disclosure during operation of such a propeller blade. Outlet vent 422 is an example of an outlet vent configured and operable to direct output air flow toward a flow separation target. It shall be appreciated that the description herein above of flow separation and a flow separation target are likewise applicable to outlet vent 422 and its configuration and operation during operation of propeller blade 320.

It shall be appreciated that providing and forming outlet vent 422 in upper surface 412 may be preferred for certain embodiments, applications, and use cases since, during operation of propeller blade 320, upper surface 412 is a relatively low pressure region exposed to lower air pressures than other locations of propeller blade 320. Such lower pressure regions may promote air flow out of outlet vent 422 and/or direct such air flow toward flow separation targets at or adjacent an upper surface of a propeller blade according to the present disclosure. Nevertheless, as further described herein, a number of other locations and positions of outlet vents are contemplated.

While outlet vent 422 is depicted as single outlet vent in the illustrated example, it is contemplated that multiple outlet vents may be provide in propeller blade 320 or other propellers according to the present disclosure. Additionally, while outlet vent 422 is depicted as being provided or formed in upper surface 412 of propeller blade 320, it is contemplated that outlet vent 422 and other outlet vents according to the present disclosure may be provided and formed in alternate locations or in additional locations in embodiments including multiple outlet vents.

In some embodiments, outlet vent 422 or other outlet vents according to the present disclosure may be provided and formed, in whole or in part, in trailing edge 408 of propeller blade 320 or a trailing edge of other propeller blades according to the present disclosure. In some embodiments, outlet vent 422 or other outlet vents according to the present disclosure may be provided and formed, in whole or in part, in lower surface 410 of propeller blade 320 or a lower surface of other propeller blades according to the present disclosure. It is further contemplated that outlet vent 422 or other outlet vents according to the present disclosure may be provided and formed in combinations of multiple surfaces of propeller blade 320 or a trailing edge of other propeller blades according to the present disclosure.

In some embodiments, outlet vent 422 or other outlet vents according to the present disclosure may be provided and formed, in whole or in part, in a combination of upper surface 412 and trailing edge 408 of propeller blade 320 or a combination of an upper surface and a trailing edge of other propeller blades according to the present disclosure. In some embodiments, outlet vent 422 or other outlet vents according to the present disclosure may be provided and formed, in whole or in part, in a combination of lower surface 410, trailing edge 408, and upper surface 412 of propeller blade 320 or a combination of a lower surface, a trailing edge, and an upper surface of other propeller blades according to the present disclosure. In some embodiments, outlet vent 422 or other outlet vents according to the present disclosure may be provided and formed, in whole or in part, in a combination of trailing edge 408 and lower surface 410 of propeller blade 320 or a combination of a trailing edge and an upper surface of other propeller blades according to the present disclosure.

Outlet vent 422 includes a ceiling 467 and a floor 457 extending into propeller blade 320 from outlet aperture 411. Ceiling 467 extends lengthwise from an upper lip 468 of intake aperture 401 positioned adjacent upper surface 412 toward trailing edge 408 of propeller blade 320. Floor 457 extends lengthwise from a lower lip 458 of intake aperture 401 positioned adjacent lower surface 412 toward trailing edge 408 of propeller blade 320. Intake vent 420 further includes first and second sidewalls 454a, 454b extending from outlet aperture 411 toward leading edge 406 of propeller blade 320. First and second sidewalls 454a, 454b bound a width of outlet vent 422.

With particular reference to FIG. 19, there is illustrated another form of an outlet vent 422′ including substantially similar features as those of outlet vent 422 but further includes one or more vanes which are configured and operable to direct a flow in air entering intake vent toward a desired direction relative to flow passage 430. In the illustrated example the one or more vanes comprise a plurality of vanes 481, 482, 483 which are configured and operable to direct air flow in air entering intake vent toward a desired direction relative to flow passage 430 generally indicated by arrows C4, C5, C6. While the one or more vanes are illustrated as including a plurality of vanes 481, 482, 483 it shall be appreciated that other embodiments including vanes may comprise any number of one or more vanes. In some embodiments, the plurality of vanes 481, 482, 483 may have fixed tunings adapted to particular altitudes or altitude ranges. In some embodiments, the plurality of vanes 481, 482, 483 may be actuatable in response to changs in propeller speed and/or changes in air flow into intake vent. Such adjustment may be passive, for example, using one or more check valves or diaphragm valves such as a diving board diaphragm. Active actuation is also contemplated and may utilize one or more actuators such as piezoelectric actuators or other actuators as will occur to one of skill in the art with the benefit and insight of the present disclosure. For example, in embodiments where active or passive actuation is utilized for vanes 481, 482, 483, actuators 494, 495, 496 may be provided in operative communication with vanes 481, 482, 483, and may be configured and provided as any of the foregoing types of actuators.

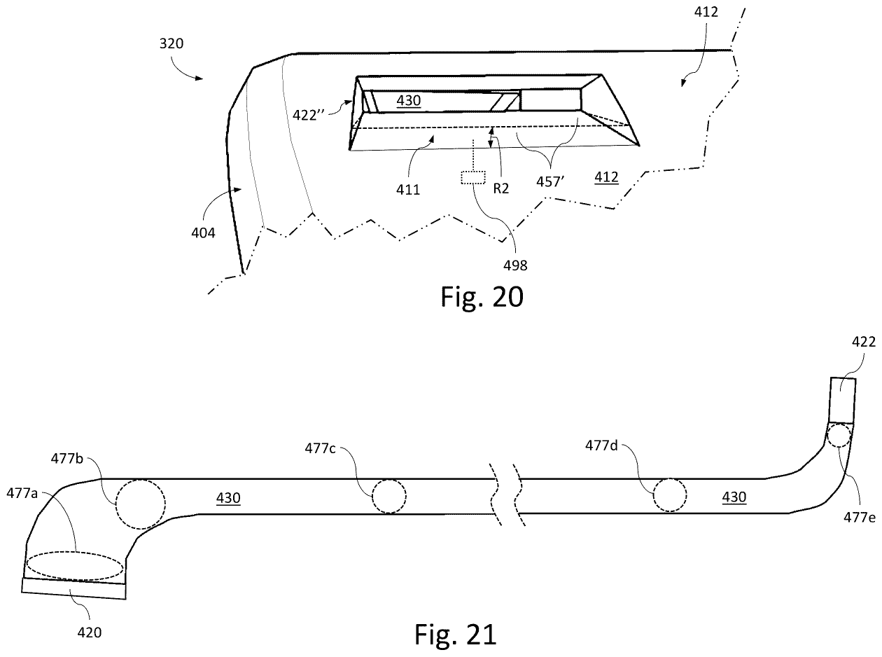

With particular reference to FIG. 20, there is illustrated another form of an outlet vent 422″ including substantially similar features as those of outlet vent 422 but further includes one or more repositionable surfaces configured and operable to move to vary an amount or direction of a flow in air entering intake vent. In the illustrated example one or more repositionable surfaces comprises repositionable floor 457′ which is configured and operable for repositioning as generally illustrated by arrow R2 to vary an area intake aperture 401 and thereby vary an amount or mass flow rate of air flow in air entering outlet vent 422″. While a single repositionable surface depicted in the illustrated embodiment, it shall be appreciated that other embodiments including vanes may comprise multiple repositionable surfaces. Repositionable floor 457′ and other repositionable surfaces according to the present disclosure may be passively actuated, for example, in response to changes in on operating speed of a propeller according to the present disclosure or actively actuated, for example, using one or more actuators which may be positioned in a propeller according to the present disclosure. Passive adjustment of repositionable floor 457′ may utilize one or more check valves or diaphragm valves such as a diving board diaphragm. Active actuation may utilize one or more actuators such as piezoelectric actuators, solenoid actuators, spring-loaded actuators, or other actuators as will occur to one of skill in the art with the benefit and insight of the present disclosure. For example, in embodiments where active or passive actuation is utilized for repositionable floor 457′, actuator 498 may be provided in operative communication with repositionable floor 457′ and may be configured and provided as any of the foregoing types of actuators.

As illustrated in FIG. 21, one or more flow control devices 477a, 477b, 477c, 477d, 477e may be provided in connection with flow passage 430 or other flow passages and plenums according to the present disclosure. In the illustrated example, the one or more flow control devices are schematically depicted in multiple example locations in flow passage 430. It shall be appreciated that one or more flow control devices may also be provided and positioned in other locations relative to flow passage 430 or other flow passages according to the present disclosure. It is contemplated that a single flow control device (e.g., a single one of flow control devices 477a, 477b, 477c, 477d, 477e) or multiple flow control devices (e.g., multiple ones of flow control devices 477a, 477b, 477c, 477d, 477e) may be provided in connection with flow passage 430. Furthermore, any one or more of flow control devices may be configured and provided in various forms such as, for example, an axial check valve, an axial pressure relief valve, a duckbill check valve, a flapper check valve, a valve with foldable inlet structures which fold to increase flow area in response to increased pressure, or an NTGD valve (which may be provided in combination with a torsional spring which is variable based on propeller RPM).

While the illustrated examples described in the contest of aircraft and aircraft propellers, it shall be appreciated that the propellers and fan assemblies of the present disclosure may be applied in a number of other technical contexts, applications and use cases. Some embodiments include one or more propellers configured for use in air boats and propulsion fans thereof. Some embodiments include one or more propellers configured for use in hovercraft and propulsion fans or lift fans thereof. Some embodiments include one or more propellers configured for use in in climate control systems and fans thereof. The disclosure further extends to and encompasses such other propeller applications as will occur to one of skill in the art with the benefit and insight of the present disclosure.

It shall be appreciated that propellers according to the present disclosure may provide any of a number of benefits. In one aspect, such propellers may provide increased operational efficiency. In another aspect such propellers may reduce operational noise of a propeller. Such reduction may be perceptible in the ambient environment as well as with an aircraft or other vehicle or system in which such propellers are implemented.

As illustrated by this detailed description, the present disclosure contemplated a plurality of embodiments including the following example embodiments.

Example embodiment 1 is a propeller apparatus comprising: a propeller blade extending along a length from a blade root to a blade tip and including a leading edge, a trailing edge, a lower surface, and an upper surface; an intake vent provided in at least one of the lower surface and the leading edge of the propeller blade adjacent the blade root and oriented toward the leading edge to intake ram air during rotation of the propeller blade; a plenum provided internal to the propeller blade and in fluid flow communication with the intake vent; and an outlet vent provided in a surface of the propeller blade adjacent the blade tip and in fluid flow communication with, the outlet vent configured to direct outlet air flow toward a flow separation target during rotation of the propeller blade effective to mitigate flow separation of air passing across the propeller blade.

Example embodiment 2 includes the features of example embodiment 1, wherein the intake vent comprises an intake aperture defined in part in the leading edge and in part in the lower surface.

Example embodiment 3 includes the features of example embodiment 1, wherein the intake vent comprises: a floor extending into the propeller blade from a lower lip positioned adjacent the lower surface of the propeller blade; first and second sidewalls extending into the propeller blade adjacent the leading edge of the propeller blade; and a ceiling extending into the propeller blade from an upper lip positioned adjacent an upper surface of the propeller blade.

Example embodiment 4 includes the features of example embodiment 1, wherein the intake vent comprises one or more vanes configured to direct intake air flow in respective directions relative to the plenum.

Example embodiment 5 includes the features of example embodiment 1, wherein a variable flow regulating device is provided in one of the intake vent, the plenum, and the outlet vent.

Example embodiment 6 includes the features of example embodiment 5, wherein the variable flow regulating device comprises a passively actuated vane.

Example embodiment 7 includes the features of example embodiment 5, wherein the variable flow regulating device comprises a passively actuated valve.

Example embodiment 8 includes the features of example embodiment 5, wherein the variable flow regulating device comprises an actively actuated vane operatively coupled with an active actuator provided in the propeller blade.

Example embodiment 9 includes the features of example embodiment 1, wherein the outlet vent is configured to provide outlet flow effective to mitigate flow separation over at least one of a portion of the upper surface and a portion of the trailing edge during rotation of the propeller blade.

Example embodiment 10 includes the features of example embodiment 9, wherein the outlet vent is positioned adjacent a region of maximal air flow over the upper surface.

Example embodiment 11 includes the features of example embodiment 1, wherein the propeller blade is coupled with and extends radially from a central hub.

Example embodiment 12 includes the features of example embodiment 1, wherein the propeller blade is configured as an aircraft lift fan propeller blade.

Example embodiment 13 includes the features of example embodiment 11, wherein a plurality of propeller blades are coupled with and extend radially from the central hub.

Example embodiment 14 includes the features of example embodiment 13, wherein the plurality of propeller blades includes a first set of radially opposing blades configured to rotate in a first direction and a second set of radially opposing blades configured to rotate in a second direction opposite the first direction.

Example embodiment 15 includes the features of example embodiment 13, wherein one or more of the plurality of propeller blades is adjustable from an extended position to a retracted position.

Example embodiment 16 includes the features of example embodiment 1, wherein the propeller blade is provided in combination with one of: an aircraft lift fan, an aircraft forward propulsion propeller system, an airboat fan, a hovercraft lift fan, a hovercraft forward propulsion fan, and a climate control systems fan.

Example embodiment 17 includes the features of example embodiment 1, wherein air flow from the outlet vent is effective to reduce operational noise of the propeller blade.

Example embodiment 18 includes the features of example embodiment 1, wherein the outlet vent is provided in the upper surface adjacent the blade tip and oriented to direct outlet air flow along the upper surface toward the trailing edge during rotation of the propeller blade.

Example embodiment 19 includes the features of example embodiment 1, wherein a majority of an outlet area of the outlet vent is provided in the upper surface adjacent the blade tip.

Example embodiment 20 includes the features of example embodiment 1, wherein the outlet vent is positioned at or adjacent a region of maximum thickness of the propeller blade.

Example embodiment 21 is a propeller apparatus comprising: a propeller blade extending along a length from a blade root to a blade tip and including a leading edge, a trailing edge, a lower surface, and an upper surface; an intake vent provided in the lower surface adjacent the blade root and oriented toward the leading edge to intake ram air during rotation of the propeller blade; a plenum provided internal to the propeller blade and in fluid flow communication with the intake vent; and an outlet vent provided in the upper surface adjacent the blade tip and oriented to direct outlet air flow along the upper surface toward the trailing edge during rotation of the propeller blade.

Example embodiment 22 includes the features of example embodiment 21 wherein the intake vent comprises: an intake aperture flush with the lower surface; a ramp floor extending into the propeller blade from the intake aperture; first and second diverging curved sidewalls extending from a leading edge of the intake aperture at an angle toward the trailing edge of the propeller blade; and an edge lip spaced apart from the ramp floor and extending from a trailing edge of the intake aperture toward the trailing edge of the propeller blade.

Example embodiment 23 includes the features of example embodiment 22, wherein the ramp floor extends lengthwise from a leading edge of the intake aperture at an angle toward the trailing edge and the upper surface of the propeller blade.

Example embodiment 24 includes the features of example embodiment 22, wherein the first and second diverging curved sidewalls bound a width of the intake vent, the width tapering from a first magnitude adjacent the edge lip to a second magnitude less than the first magnitude adjacent a leading edge of the intake aperture.

Example embodiment 25 includes the features of example embodiment 21, wherein the intake vent is configured as a NACA scoop.

Example embodiment 26 includes the features of example embodiment 21, wherein the outlet vent is configured to provide outlet flow effective to mitigate flow separation over at least a portion of the upper surface during rotation of the propeller blade.

Example embodiment 27 includes the features of example embodiment 21, wherein the outlet vent is oriented to direct air flow across the upper surface in a direction opposing a rotation direction of the propeller blade.

Example embodiment 28 includes the features of example embodiment 27, wherein the air flow directed across the upper surface is effective to mitigate boundary layer flow separation.

Example embodiment 29 includes the features of example embodiment 27, wherein the outlet vent is positioned in or adjacent a region of maximal air flow over the upper surface.

Example embodiment 30 includes the features of example embodiment 21, wherein the propeller blade is configured as an aircraft lift fan propeller blade.

Example embodiment 31 includes the features of example embodiment 21, wherein the propeller blade is coupled with and extends radially from a central hub.

Example embodiment 32 includes the features of example embodiment 31, wherein the central hub is driven by an electric motor.

Example embodiment 33 includes the features of example embodiment 31, wherein a plurality of propeller blades are coupled with and extend radially from the central hub.

Example embodiment 34 includes the features of example embodiment 33, wherein the plurality of propeller blades includes a first set of radially opposing blades configured to rotate in a first direction and a second set of radially opposing blades configured to rotate in a second direction opposite the first direction.

Example embodiment 35 includes the features of example embodiment 13, wherein one or more of the plurality of propeller blades is adjustable from an extended position to a retracted position.

Example embodiment 36 includes the features of example embodiment 1, wherein the propeller blade is provided and utilized in one of: an aircraft lift fan, an aircraft forward propulsion propeller system, an airboat fan, a hovercraft lift fan, a hovercraft forward propulsion fan, and a climate control systems fan.

Example embodiment 37 includes the features of example embodiment 1, wherein air flow from the outlet vent is effective to reduce operational noise of the propeller blade.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A propeller apparatus comprising:
a propeller blade extending along a length from a blade root to a blade tip and including a leading edge, a trailing edge, a lower surface, and an upper surface;
an intake vent provided in at least one of the lower surface and the leading edge of the propeller blade adjacent the blade root and oriented toward the leading edge to intake ram air during rotation of the propeller blade;
a plenum provided internal to the propeller blade and in fluid flow communication with the intake vent; and
an outlet vent provided in a surface of the propeller blade adjacent the blade tip and in fluid flow communication with, the outlet vent configured to direct outlet air flow toward a flow separation target during rotation of the propeller blade effective to mitigate flow separation of air passing across the propeller blade.

2. The propeller apparatus of claim 1, wherein the intake vent comprises an intake aperture defined in part in the leading edge and in part in the lower surface.

3. The propeller apparatus of claim 1, wherein the intake vent comprises:
a floor extending into the propeller blade from a lower lip positioned adjacent the lower surface of the propeller blade;
first and second sidewalls extending into the propeller blade adjacent the leading edge of the propeller blade; and
a ceiling extending into the propeller blade from an upper lip positioned adjacent an upper surface of the propeller blade.

4. The propeller apparatus of claim 1, wherein the intake vent comprises one or more vanes configured to direct intake air flow in respective directions relative to the plenum.

5. The propeller apparatus of claim 1, wherein a variable flow regulating device is provided in one of the intake vent, the plenum, and the outlet vent.

6. The propeller apparatus of claim 5, wherein the variable flow regulating device comprises a passively actuated vane.

7. The propeller apparatus of claim 5, wherein the variable flow regulating device comprises a passively actuated valve.

8. The propeller apparatus of claim 5, wherein the variable flow regulating device comprises an actively actuated vane operatively coupled with an active actuator provided in the propeller blade.

9. The propeller apparatus of claim 1, wherein the outlet vent is configured to provide outlet flow effective to mitigate flow separation over at least one of a portion of the upper surface and a portion of the trailing edge during rotation of the propeller blade.

10. The propeller apparatus of claim 9, wherein the outlet vent is positioned in or adjacent a region of maximal air flow over the upper surface.

11. The propeller apparatus of claim 1, wherein the propeller blade is coupled with and extends radially from a central hub.

12. The propeller apparatus of claim 1, wherein the propeller blade is configured as an aircraft lift fan propeller blade.

13. The propeller apparatus of claim 11, wherein a plurality of propeller blades are coupled with and extend radially from the central hub.

14. The propeller apparatus of claim 13, wherein the plurality of propeller blades includes a first set of radially opposing blades configured to rotate in a first direction and a second set of radially opposing blades configured to rotate in a second direction opposite the first direction.

15. The propeller apparatus of claim 13, wherein one or more of the plurality of propeller blades is adjustable from an extended position to a retracted position.

16. The propeller apparatus of claim 1, wherein the propeller blade is provided in combination with one of: an aircraft lift fan, an aircraft forward propulsion propeller system, an airboat fan, a hovercraft lift fan, a hovercraft forward propulsion fan, and a climate control systems fan.

17. The propeller apparatus of claim 1, wherein air flow from the outlet vent is effective to reduce operational noise of the propeller blade.

18. The propeller apparatus of claim 1, wherein the outlet vent is provided in the upper surface adjacent the blade tip and oriented to direct outlet air flow along the upper surface toward the trailing edge during rotation of the propeller blade.

19. The propeller apparatus of claim 1, wherein a majority of an outlet area of the outlet vent is provided in the upper surface adjacent the blade tip.

20. The propeller apparatus of claim 1, wherein the outlet vent is positioned at or adjacent a region of maximum thickness of the propeller blade.
